(19) United States
(12) Patent Application Publication
(10) Pub. No.: US 2026/0178884 A1
(43) Pub. Date: Jun. 25, 2026

(54) INFORMATION PROCESSING DEVICE, INFORMATION PROCESSING METHOD, AND INFORMATION PROCESSING SYSTEM

(71) Applicants: KABUSHIKI KAISHA TOSHIBA, Kawasaki-shi (JP); TOSHIBA ELECTRONIC DEVICES & STORAGE CORPORATION, Kawasaki-shi (JP)

(72) Inventors: Kozo KINOSHITA, Fujisawa Kanagawa (JP); Takuya Matsumoto, Kawasaki Kanagawa (JP); ArunKumar Kalakanti, Bangalore (IN); Saoni Das, Bangalore (IN)

(73) Assignees: KABUSHIKI KAISHA TOSHIBA, Kawasaki-shi (JP); TOSHIBA ELECTRONIC DEVICES & STORAGE CORPORATION, Kawasaki-shi (JP)

(21) Appl. No.: 19/376,156

(22) Filed: Oct. 31, 2025

(30) Foreign Application Priority Data
Dec. 25, 2024 (JP) 2024-229457

(51) Int. Cl. G06N 3/0455; G06N 3/08; G06V 10/72; G06V 10/766; G06V 10/774

(52) U.S. Cl. CPC G06N 3/0455; G06N 3/08; G06V 10/72; G06V 10/766; G06V 10/774

(57) ABSTRACT

An information processing apparatus includes a processing circuit. The processing circuit interpolates a missing value of data in which first data is removed with a first interpolation value and acquires second data, trains an auto encoder model that outputs the first data when the second data is input, interpolates a missing value of data in which third data is removed with a plurality of second interpolation values and acquires a plurality of pieces of fourth data, calculates an error between the third data and output data obtained by inputting the plurality of pieces of fourth data to the auto encoder model, updates the first interpolation value with an interpolation value extracted from the plurality of second interpolation values based on the error, and repeatedly executes processing from acquisition of the second data using the updated first interpolation value, thereby optimizing the first interpolation value and the auto encoder model.

### CROSS REFERENCE TO THE RELATED APPLICATIONS

This application is based upon and claims the benefit of priority from the Japanese Patent Application No. 2024-229457, filed on Dec. 25, 2024, the entire contents of which are incorporated herein by reference.

### FIELD

This disclosure relates to an information processing device, an information processing method, and an information processing system.

### BACKGROUND

In manufacturing and selling products, it is important to increase and stabilize yield in a manufacturing process. Viewing all products and appropriately acquiring information on a position, a region, and the like where defect occurred usually lead to yield stabilization. For example, when a large number of components are collectively manufactured, by determining conditions under which the components are appropriately manufactured when viewed as a whole, it is possible to maintain high final yield.

As such, when a large number of components are provided as a whole, overall tendency may be acquired as an image or the like by a sensor or the like in an inspection process, but a defect may occur in the image or the like due to performance of the sensor or the like. Since interpolation of the missing value may affect the overall tendency, interpolation needs to be performed appropriately.

### BRIEF DESCRIPTION OF DRAWINGS

FIG. 1 is a diagram illustrating an example of a process flow according to an embodiment;

FIG. 2 is a diagram illustrating an example of missing data generation according to the embodiment;

FIG. 3 is a diagram illustrating an example of interpolation data generation according to the embodiment;

FIG. 4 is a conceptual diagram illustrating an example of an auto encoder model according to the embodiment;

FIG. 5 is a conceptual diagram illustrating an example of learning of a model that estimates a state according to the embodiment;

FIG. 6 is a conceptual diagram illustrating an example of learning of the model that estimates a state according to the embodiment;

FIG. 7 is a conceptual diagram illustrating an example of learning of the model that estimates a state according to the embodiment;

FIG. 8 is a conceptual diagram illustrating an example of learning of the model that estimates a state according to the embodiment; and

FIG. 9 is a conceptual diagram illustrating an example of learning of the model that estimates a state according to the embodiment.

### DETAILED DESCRIPTION

According to an embodiment, an information processing apparatus includes a processing circuit. The processing circuit interpolates a missing value of data in which first data is removed with a first interpolation value and acquires second data, trains an auto encoder model that outputs the first data when the second data is input, interpolates a missing value of data in which third data is removed with a plurality of second interpolation values and acquires a plurality of pieces of fourth data, calculates an error between the third data and output data obtained by inputting the plurality of pieces of fourth data to the auto encoder model, updates the first interpolation value with an interpolation value extracted from the plurality of second interpolation values based on the error, and repeatedly executes processing from acquisition of the second data using the updated first interpolation value, thereby optimizing the first interpolation value and the auto encoder model.

Hereinafter, embodiments are described with reference to the drawings. An information processing apparatus, an information processing method, and an information processing system according to the present disclosure implement information processing that appropriately estimates a certain tendency from data having the tendency as a whole even when the data has a missing value.

The data may be, for example, image data, audio data, or other types of binary data, or may be text data. As a non-limiting example, a mode related to a semiconductor device may be used, but the mode of the present disclosure is also applicable to other various fields.

An information processing apparatus of the present disclosure operates as an estimation apparatus that estimates an overall tendency related to data having a missing value from the data. An information processing apparatus of the present disclosure operates as a learning apparatus that optimizes a model used for estimation in the information processing apparatus described above.

An information processing apparatus of the present disclosure may be an information processing apparatus that realizes operations of both the learning apparatus and the estimation apparatus described above. The information processing described above can also be realized by an information processing system in which a plurality of information processing apparatuses operate in cooperation at least at a certain partial timing, instead of one information processing apparatus.

### First Embodiment

First, one embodiment of an information processing apparatus as a training apparatus is described. The information processing apparatus includes, for example, a storage circuit and a processing circuit. The processing circuit is formed as a circuit for training. The storage circuit stores necessary data.

The processing circuit may use a dedicated digital or analog circuit such as an application specific integrated circuitry (ASIC) or a digital signal processor (DSP), use a general-purpose processor such as a central processing unit (CPU) or a graphics processing unit (GPU), or use a programmable circuit such as a field programmable gate array (FPGA).

The storage circuit may be provided inside the information processing apparatus or may be capable of acquiring data by an appropriate interface provided outside. The storage circuit may store data necessary for training, data of training in progress, and data after completion of training. When the information processing apparatus specifically realizes information processing by software using a processing circuit that is a hardware resource, a program or an execution file for controlling the information processing by the software or data equivalent thereto may be stored in the storage circuit.

As described above, the configuration may include several storage circuits and processing circuits connected to each other as an information processing system. Hereinafter, processing executed by the information processing apparatus can be realized by appropriately using the processing circuit and the storage circuit.

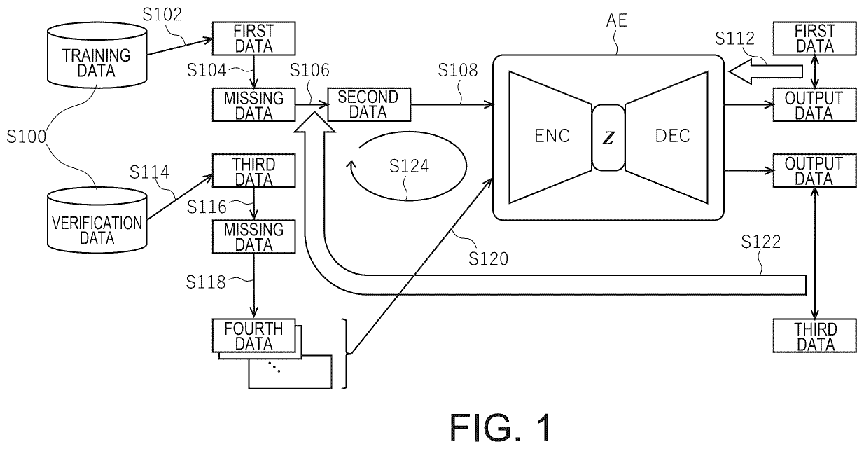

FIG. 1 is a diagram illustrating an example of a process flow according to the embodiment. In the embodiment, the information processing apparatus generates a model that appropriately generates data without a defect from data with a defect.

First, the information processing apparatus prepares a training data group and a verification data group (S100). The data may be stored in a storage circuit outside the information processing apparatus, for example, a storage or the like, and may be prepared to be usable by the information processing apparatus at a timing when the information processing apparatus uses the data. The training data is data used for learning an auto encoder model AE. The verification data is data used for verification of the auto encoder model AE and is data for optimizing an interpolation value.

The information processing apparatus extracts first data for executing training of the auto encoder model AE from the training data (S102). Subsequently, the information processing apparatus removes first data and generates missing data (S104).

For example, when input data (training data and verification data) is image data, the information processing apparatus can generate data by removing a part of the image. The information processing apparatus can similarly generate missing data in audio data or other types of binary data, or text data.

The information processing apparatus can generate missing data according to characteristics of a sensor that acquires the input data. For example, when the input data is image data, the information processing apparatus can generate missing data by removing the image data based on a defect that can occur in the sensor that acquires the image.

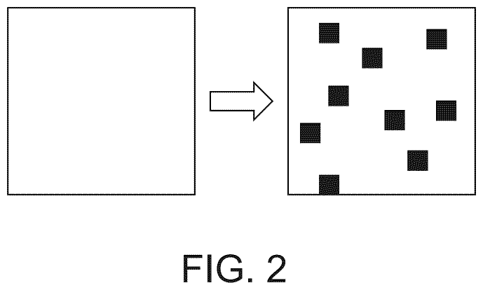

FIG. 2 is a diagram illustrating an example of missing data generation for image data according to the embodiment. The information processing apparatus generates missing data illustrated on the right side by missing values of a part or a plurality of regions regarding a certain image (for example, first data) illustrated on the left side. In the drawing on the right side, portions filled with black indicate missing portions.

Referring back to FIG. 1, the information processing apparatus interpolates the missing portions of the generated missing data using a first interpolation value to generate second data (S106). In a first iteration, a predetermined initial value may be set as the first interpolation value. As such, the information processing apparatus interpolates missing data and generates data that can be input to the auto encoder model AE.

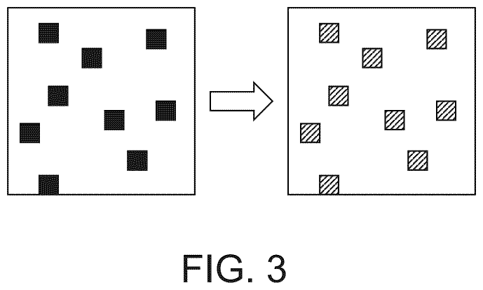

FIG. 3 is a diagram illustrating an example of interpolation data generation for image data according to the embodiment. The information processing apparatus interpolates missing portions of missing data illustrated on the left side using the first interpolation value. The first interpolation value is set, for example, between a minimum value and a maximum value of luminance. The drawing on the right side illustrates interpolated data (second data) and shaded portions illustrate portions interpolated by the first interpolation value.

Referring back to FIG. 1, the information processing apparatus inputs the second data to the auto encoder model AE and acquires output data for the second data (S108). The auto encoder model AE is a model that includes an encoder ENC and a decoder DEC, converts an image input by the encoder ENC into a latent variable Z (latent vector), and converts the latent variable Z into output data by the decoder DEC.

The information processing apparatus compares the output data in which the second data is input to the auto encoder model AE with the first data and performs learning so that the auto encoder model AE becomes a model that outputs the first data when the second data is input (S112). Such learning may be performed based on a method using a general auto encoder.

The information processing apparatus continues learning of the auto encoder model AE until optimization is completed. In the learning, the information processing apparatus can extract a plurality of pieces of first data from the training data as necessary and execute optimization. In the learning, the information processing apparatus may generate a plurality of pieces of missing data from the same first data and generate the second data from the plurality of pieces of missing data using the first interpolation value.

An end condition of learning is set so that learning of the auto encoder model AE is appropriately executed. The end condition may be, for example, a condition that a predetermined number of iterations are executed, a condition that an operation is executed for a predetermined period of time, a condition that an evaluation function falls below a predetermined threshold value, or the like.

As another mode, before the learning, the information processing apparatus may first learn the auto encoder model AE so that the first data is output when the first data is input without using the missing data, and execute learning using the second data using the learned parameter. That is, the information processing apparatus can use the auto encoder model AE learned in advance so that the first data is output when the first data is input. Here, the processing of S112 can also be executed using a technique such as distillation or dropout of a network of the auto encoder model AE.

After learning using the training data is once completed in the auto encoder model AE, the information processing apparatus proceeds to processing using verification data. The information processing apparatus extracts third data from the verification data (S114). Subsequently, the information processing apparatus generates missing data of fourth data similarly to the first data (S116).

Next, the information processing apparatus generates a plurality of pieces of fourth data using a plurality of second interpolation values for missing data for the acquired third data (S118). The second interpolation value may or may not include the first interpolation value, but since it is preferable to compare another second interpolation value with the first interpolation value, it is preferable that the second interpolation value includes the first interpolation value.

For example, the information processing apparatus can randomly extract a plurality of values from an allowable range of interpolation values and obtain a plurality of second interpolation values. For example, the information processing apparatus can extract a plurality of values at equal intervals in the range of interpolation values and obtain a plurality of second interpolation values.

The information processing apparatus inputs a plurality of pieces of fourth data to the auto encoder model AE and acquires output data (S120). Then, the information processing apparatus updates the first interpolation value by comparing the plurality of pieces of output data with the third data (S122).

For example, the information processing apparatus may acquire an error (residual error) between the plurality of pieces of output data and the third data, extract the second interpolation value corresponding to the output data with a smallest error, and update the first interpolation value with the extracted second interpolation value.

After the first interpolation value is updated, the information processing apparatus can repeatedly execute the processing from S102 to S122 until the end condition is achieved (S124). That is, the information processing apparatus learns the auto encoder model AE using the new first interpolation value and updates the first interpolation value using the second interpolation value for the learned auto encoder model AE.

As such, the information processing apparatus alternately repeats update of the auto encoder model AE and update of the first interpolation value that complements the missing value. The information processing apparatus can repeatedly execute such processing until conditions suitable for completing learning are finally satisfied, for example, until an error (for example, a minimum value, an average value, or the like) between output data obtained by inputting the fourth data into the auto encoder model AE and the third data falls below a predetermined threshold value, until update of the first interpolation value is performed a predetermined number of times, or the like.

Note that the information processing apparatus can not only select the second interpolation value in the processing of S118 randomly or uniformly but also can use other selection methods. For example, selection may be made according to normal distribution or the like centered on the current first interpolation value.

The selection can be changed depending on the number of execution of S122. For example, the information processing apparatus may control a parameter such as standard deviation in normal distribution or the like according to the number of executions of S122.

As another example, the information processing apparatus may change a method of selecting the second interpolation value to be selected in the next iteration based on the error between the output data and the third data. The information processing apparatus can select the next second interpolation value according to the error to not fall into local optimum, for example, as in simulated annealing or the like.

In the processing of S122, the information processing apparatus can extract the second interpolation value in which the error between the output data and the third data is minimized and set the second interpolation value as the first interpolation value of the next iteration. The information processing apparatus is not limited thereto, and may calculate the first interpolation value in the next iteration from the second interpolation value (and the first interpolation value) based on the error between the output data and the third data.

For example, the information processing apparatus may update the first interpolation value based on various statistical values such as an average value obtained by weighting second interpolation values based on the error between the output data obtained by inputting the fourth data to the auto encoder model AE and the third data.

As described above, according to the embodiment, by alternately repeating update of the auto encoder model and update of the first interpolation value, it is possible to realize optimization of a model that estimates original data from data with a defect. Using original data that is restored as such, it is possible to know an appropriate overall data tendency from data with a defect. The overall data tendency may be determined based on rules or may be determined using a learned model that outputs the overall data tendency.

### Second Embodiment

In the first embodiment described above, an example in which data with a defect is restored using an auto encoder model is described. In the present embodiment, a mode for enhancing accuracy of restoration by the auto encoder model is further described.

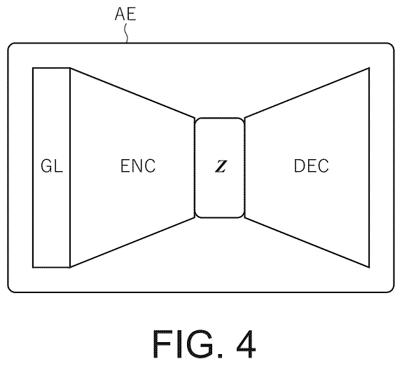

FIG. 4 is a diagram conceptually illustrating an example of an auto encoder model AE according to the embodiment. The auto encoder model AE includes, for example, a Gaussian layer GL in addition to the encoder ENC and the decoder DEC.

The Gaussian layer GL is provided before an input layer of the encoder ENC and superimposes Gaussian noise on data to be input to the encoder ENC. When the second data and the fourth data in FIG. 1 are input to the auto encoder model AE, the information processing apparatus first adds noise to the data by the Gaussian layer GL and inputs the data to which the noise is added to the encoder ENC.

The Gaussian layer GL can generate noise, for example, by a distribution according to a noise superimposition parameter and superimpose the noise on the data, instead of continuously adding predetermined noise to the data.

The information processing apparatus can optimize the auto encoder model AE and the first interpolation value using the auto encoder model AE of FIG. 4 instead of the auto encoder model AE of FIG. 1.

As described above, in the embodiment, the Gaussian layer GL that superimposes noise on data to be input to the encoder ENC of the auto encoder model AE can be provided. By providing the Gaussian layer GL, it is possible to realize more robust model learning that considers variation due to noise of input data acquired by the sensor, an individual difference of the sensor, and the like.

### Third Embodiment

In each of the above-described embodiments, a model that restores data without a defect from missing data is described. It is possible to acquire data without a defect using such model, and thus, it is possible to acquire tendency of overall data by various methods such as a generally known rule-based method or a method using a model learned by machine learning.

In the present embodiment, a non-limiting example that estimates tendency of the entire data using the auto encoder model AE described in each of the above-described embodiments is described. Note that, hereinafter, description is made using a mode including the Gaussian layer GL described in the second embodiment, but similar processing can be realized even when the Gaussian layer GL illustrated in FIG. 4 is not provided, and thus, effects similar to those of the first embodiment can be exhibited.

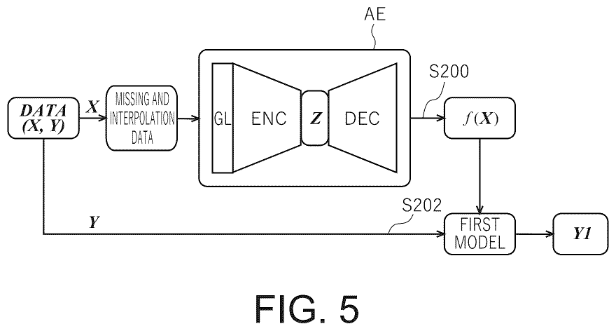

FIG. 5 is a diagram conceptually illustrating a configuration of a model that acquires a state Y (data indicating a state) from data in which data X (data indicating characteristics) is removed according to the embodiment and an example of learning of such model. The auto encoder model AE may be formed according to each of the above-described embodiments.

The information processing apparatus removes and interpolates the data X by processing similar to the above-described embodiment, inputs the interpolated data to the auto encoder model AE, and acquires estimated restoration data f(X) of the data X (S200). As an interpolation value, the first interpolation value optimized according to the above-described embodiment can be used.

The information processing apparatus optimizes a first model so that the state Y is output when the acquired estimated restoration data f(X) and the data X are input (S202). In the state Y for the data X, training data can be generated from data such as experimental values and theoretical values.

The first model may be, for example, a linear regression model. Here, the information processing apparatus can optimize the model by setting the state Y as an objective variable with the data X as an explanatory variable. A method of linear regression may be freely selected.

As another non-limiting example, the first model may be another model such as multi-layer perceptron (MLP), convolutional neural network (CNN), or graph neural network (GNN), and an information processing apparatus of such example can execute learning of the model by a freely selected method suitable for each model.

The first model learned as such is optimized as a model for acquiring a state Y1 (first state) from a result of inputting the data X with a defect to the auto encoder model AE.

As described above, according to the embodiment, it is possible to estimate a state indicating a tendency of overall data from data with a defect using an optimized interpolation value, an optimized auto encoder model AE, and an optimized first model.

Note that the information processing apparatus can execute training of the auto encoder model AE and optimization of the first interpolation value in parallel with training of the first model.

### Fourth Embodiment

In the third embodiment, a state is predicted using restoration data output from the auto encoder model AE, but in the present embodiment, a model for predicting a state using a latent variable Z output from the encoder ENC of the auto encoder model AE is described.

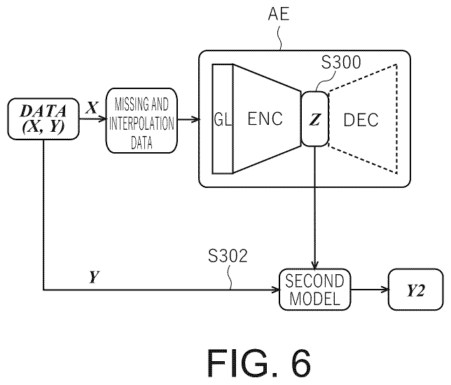

FIG. 6 is a diagram conceptually illustrating a configuration of a model that acquires a state Y from data in which data X is removed according to the embodiment and an example of learning of such model. The auto encoder model AE may be formed according to each of the above-described embodiments.

The information processing apparatus removes the data X as in each of the above-described embodiments, interpolates the data X with an optimized first interpolation value, and inputs the data X to the optimized auto encoder model AE. The information processing apparatus acquires the latent variable Z output from the encoder ENC of the auto encoder model AE (S300).

The information processing apparatus trains the second model so that the state Y is acquired from the latent variable Z (S302). The second model may be formed by, for example, a decision tree. When the second model is formed by the decision tree, the information processing apparatus can train the second model so that the state Y is estimated from the latent variable Z by a machine learning method such as XGBoost.

The latent variable Z that is data dimensionally compressed by the encoder ENC is restored to data without a defect by the decoder DEC. The data without a defect is data of a form in which a state can be extracted from the data itself. That is, the latent variable Z is a vector having a feature value of the state Y for the input data X and having less dimension.

The second model is a model formed to extract a feature value of the state Y from the latent variable Z and output the state Y. The information processing apparatus is optimized so that the state Y is extracted from the latent variable Z having a feature of the state Y as such.

For example, when an interpolation value optimized from the removed data X and the latent variable Z acquired via the auto encoder model AE are input, the information processing apparatus executes machine learning (for example, training by XGBoost) to output the state Y as teacher data, thereby optimizing the second model.

The second model of which optimization is completed is formed as a model that outputs a state Y2 (second state) when the latent variable Z is input.

As described above, according to the embodiment, it is possible to estimate a state indicating a tendency of overall data from data with a defect using an optimized interpolation value, an optimized auto encoder model AE, and an optimized second model.

Note that, similarly to the third embodiment, the information processing apparatus can execute training of the auto encoder model AE and optimization of the first interpolation value in parallel with training of the second model as multi-task learning.

### Fifth Embodiment

In the third embodiment, estimation of a state from data output from the auto encoder model AE by the first model is described, and in the fourth embodiment, estimation of a state from a latent variable extracted from the auto encoder model AE by the second model is described. Such estimations may be separately operated as described above, but it is also possible to perform learning that estimates the state Y using both results.

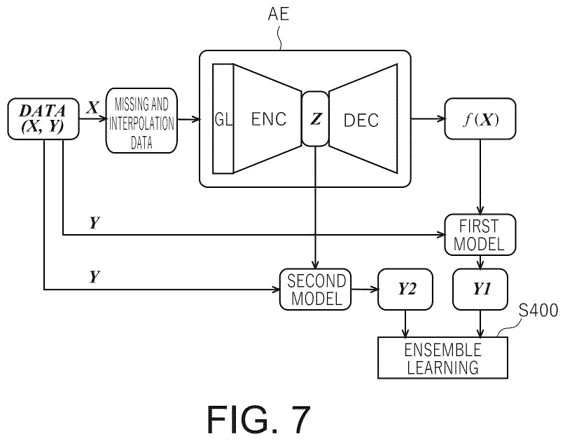

FIG. 7 is a diagram conceptually illustrating a configuration of a model that acquires a state Y from data in which data X is removed according to the embodiment and an example of learning of such model. The auto encoder model AE, the first model, and the second model have the same configurations as those of the above-described embodiments.

The information processing apparatus executes ensemble learning using optimization results of the first model and the second model and trains the models (S400). As a non-limiting example, the information processing apparatus can execute ensemble learning after optimization of the first interpolation value and optimization of the auto encoder model AE. As a non-limiting example, the information processing apparatus can also realize training of the first interpolation value, the auto encoder model AE, the first model, and the second model by ensemble learning.

Such training can be performed as multi-task learning as described above.

More specifically, the information processing apparatus trains the first model and the second model according to processing of the third embodiment and the fourth embodiment using, for example, the first interpolation value and the auto encoder model AE learned from the learning data. The information processing apparatus can acquire data (X, Y), that is, the input data X and the state data Y, from the same or different pieces of learning data for the models and can realize learning based on the data (X, Y).

By executing ensemble learning based on the state Y1 output from the first model and the state Y2 output from the second model, the information processing apparatus can realize learning of a model in which over-learning in the first model and the second model is prevented.

As described above, according to the embodiment, it is possible to further improve accuracy of the optimized interpolation value, the optimized auto encoder model AE, the optimized first model, and the optimized second model. As a result, it is possible to realize estimation of a state indicating a tendency of overall data from data with a defect with higher accuracy.

### Sixth Embodiment

In addition to using the auto encoder model AE described above, it is also possible to form a model that directly acquires a state Y from missing data. Such model can be formed by, for example, a model such as XGBoost that estimates a state from missing data.

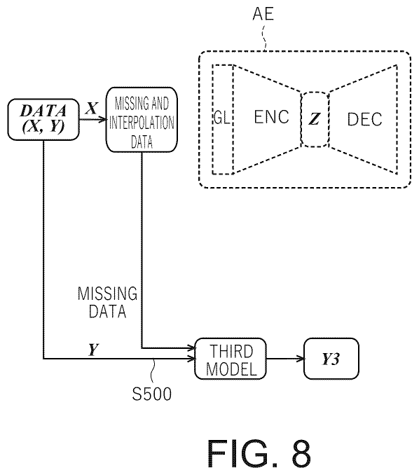

FIG. 8 is a diagram conceptually illustrating a third model that directly estimates the state Y from missing data according to the embodiment. The information processing apparatus acquires missing data from data X and trains the third model to output the state Y when the missing data is input (S500). Such training is implemented by executing learning such as XGBoost that supports missing data.

The third model is different from the second model in that a model such as XGBoost is directly applied to the missing data. It is also possible to perform learning using such third model as a weak learning machine. Therefore, in the embodiment, a further learning method using this third model as a weak learning machine is described.

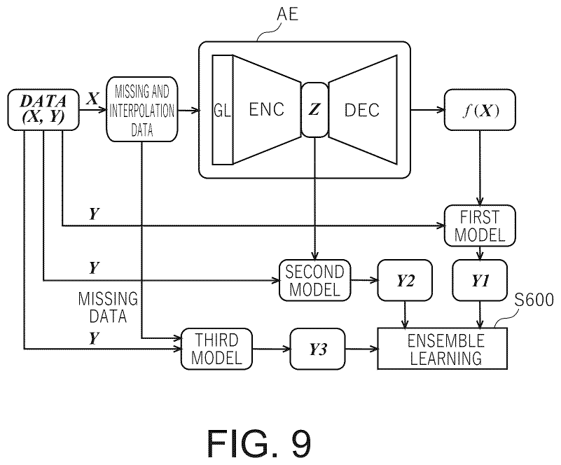

FIG. 9 is a diagram conceptually illustrating a configuration of a model that acquires a state Y after data X is removed according to the embodiment and an example of learning of such model. The auto encoder model AE, the first model, and the second model have the same configurations as those of the above-described embodiments. The third model has the same configuration as the model illustrated in FIG. 8.

The information processing apparatus first generates missing data from the data X by processing similar to each of the above-described embodiments. The information processing apparatus generates interpolation data using a first interpolation value for the missing data.

The information processing apparatus inputs stored data to the auto encoder model AE and acquires output data f(X) and a latent variable Z. The information processing apparatus inputs the output data f(X) to the first model and acquires a state Y1. Along with such processing, the information processing apparatus inputs the latent variable Z to the second model and acquires a state Y2. The information processing apparatus inputs the missing data in which the data X is removed to the third model and acquires a state Y3 (third state).

The information processing apparatus executes ensemble learning using the states Y1, Y2, and Y3, thereby executing learning that improves accuracy of each model.

As a non-limiting example, the information processing apparatus may learn the first model, the second model, and the third model by ensemble learning.

As a non-limiting example, the information processing apparatus may learn the first interpolation value, the auto encoder model AE, the first model, the second model, and the third model by ensemble learning.

Ensemble learning is executed with reference to output values by a plurality of paths that output the same state, thereby improving accuracy of each model. Such learning can be performed as multi-task learning as necessary.

As described above, according to the embodiment, not only optimization of the auto encoder model AE but also optimization of the model that acquires an overall tendency of data can be realized. That is, the information processing apparatus can generate a highly accurate model by ensemble learning using at least any two of the first state, the second state, and the third state acquired by different methods.

Using the optimized model, the information processing apparatus can form a model that restores data having a defect and/or a model that estimates a state indicating a tendency of the data as a whole. The scope of the present disclosure includes a mode in which the information processing apparatus uses such optimized model.

It is possible to form an information processing system that realizes restoration from data with a defect and/or estimation of a state as an overall tendency from data with a defect by a plurality of information processing apparatuses.

As a non-limiting example, optimization and optimized models in the present disclosure can be applied to characteristics and wafer states of semiconductor devices. For example, the data X (characteristic) can be an electrical characteristic. As a non-limiting example, the electrical characteristic may be a characteristic such as a leakage current, a withstand voltage, or an on-resistance.

For example, the state Y may indicate an electronic state of a device or a state of a semiconductor device predicted from an electrical characteristic. As a non-limiting example, the state Y can be used to estimate an impurity concentration or a processing shape (trench width, depth, taper angle, or the like) of a device, and can be used to estimate accuracy of photolithography, processing accuracy, and the like that affect the shape. The state Y can be used as an electrical characteristic in estimating another electrical characteristic from the electrical characteristic.

Data with a defect may be, for example, data indicating a characteristic equal to or less than a certain threshold value. For example, a defect may be a defect such as adhesion of particles such as dirt and dust in an image or a withstand voltage value. The defect may include failure. The failure may include a case in which, for example, when a certain characteristic is failure, a subsequent characteristic is not measured. As such, it is possible to handle a defect of any characteristic such as a defect in an image or a value related to a current value or a voltage value.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus comprising:
a processing circuit configured to:
interpolate a missing value of data in which first data is removed with a first interpolation value and acquires second data,
train an auto encoder model that outputs the first data when the second data is input,
interpolate a missing value of data in which third data is removed with a plurality of second interpolation values and acquires a plurality of pieces of fourth data,
calculate an error between the third data and output data obtained by inputting the plurality of pieces of fourth data to the auto encoder model,
update the first interpolation value with an interpolation value extracted from the plurality of second interpolation values based on the error, and
repeatedly execute processing from acquisition of the second data using the updated first interpolation value, thereby optimizing the first interpolation value and the auto encoder model.

2. The information processing apparatus according to claim 1, wherein the auto encoder model includes a layer that superimposes Gaussian noise on input data.

3. The information processing apparatus according to claim 1, wherein the processing circuit generates a first model that performs linear regression on state data for input data having a missing value and output data that is the input data interpolated with the first interpolation value and input to the auto encoder model.

4. The information processing apparatus according to claim 3, wherein the processing circuit is further configured to:
interpolate input data with a missing value with the first interpolation value and inputs the interpolated input data to the auto encoder model, thereby acquiring a latent variable, and
train a second model that acquires state data for the input data from the latent variable based on the latent variable and the state data.

5. The information processing apparatus according to claim 4, wherein the processing circuit interpolates input data with a missing value with the first interpolation value and inputs the interpolated input data to the auto encoder model and the first model, thereby acquiring a first state, interpolates the input data with the first interpolation value and inputs the interpolated input data to the auto encoder model and the second model, thereby acquiring a second state, and executes ensemble learning based on the first state and the second state.

6. The information processing apparatus according to claim 4, wherein the processing circuit is further configured to train a third model that outputs state data when input data with a missing value is input, based on state data acquired by inputting the input data to the third model and state data for the input data.

7. The information processing apparatus according to claim 6, wherein the processing circuit interpolates input data with a missing value with the first interpolation value and inputs the interpolated input data to the auto encoder model and the first model, thereby acquiring a first state, interpolates the input data with the first interpolation value and inputs the interpolated input data to the auto encoder model and the second model, thereby acquiring a second state, inputs the input data to the third model, thereby acquiring a third state, and executes ensemble learning based on the first state, the second state, and the third state.

8. An information processing apparatus that acquires a state for input data with a missing value from the input data using a model trained by the information processing apparatus according to claim 1.

9. An information processing method for causing a processing circuit to:
interpolate a missing value of data in which first data is removed with a first interpolation value, thereby acquiring second data;
train an auto encoder model that outputs the first data when the second data is input;
interpolate a missing value of data in which third data is removed with a plurality of second interpolation values, thereby acquiring a plurality of pieces of fourth data;
calculate an error between the third data and output data obtained by inputting the plurality of pieces of fourth data to the auto encoder model;
update the first interpolation value with an interpolation value extracted from the plurality of second interpolation values based on the error; and
repeatedly execute processing from acquisition of the second data using the updated first interpolation value, thereby optimizing the first interpolation value and the auto encoder model.

10. An information processing system comprising:
one or a plurality memories; and
one or a plurality of processing circuits, wherein
the information processing system causes at least one of the plurality of processing circuits to perform:
interpolating a missing value of data in which first data is removed with a first interpolation value, thereby acquiring second data,
training an auto encoder model that outputs the first data when the second data is input,
interpolating a missing value of data in which third data is removed with a plurality of second interpolation values, thereby acquiring a plurality of pieces of fourth data,
calculating an error between the third data and output data obtained by inputting the plurality of pieces of fourth data to the auto encoder model,
updating the first interpolation value with an interpolation value extracted from the plurality of second interpolation values based on the error, and
repeatedly executing processing from acquisition of the second data using the updated first interpolation value, thereby optimizing the first interpolation value and the auto encoder model.
